(19) United States
(12) Patent Application Publication
(10) Pub. No.: US 2024/0333893 A1
(43) Pub. Date: Oct. 3, 2024

(54) PROJECTOR AND CONTROL APPARATUS

(71) Applicant: SEIKO EPSON CORPORATION, Tokyo (JP)

(72) Inventors: Shinichi WAKABAYASHI, SUWA-SHI (JP); Tatsuya TAKAHASHI, AZUMINO-SHI (JP)

(21) Appl. No.: 18/618,440

(22) Filed: Mar. 27, 2024

(30) Foreign Application Priority Data
Mar. 28, 2023 (JP) 2023-051524

(51) Int. Cl. H04N 9/31; G03B 21/14

(52) U.S. Cl. CPC H04N 9/3185; G03B 21/142

(57) ABSTRACT

A projector includes an image formation apparatus, a projection optical apparatus that projects image light formed by the image formation apparatus, an optical path shifter that shifts the optical path of the image light with respect to a reference position where the image light is projected, a vibration detection sensor that detects vibration that affects the position where the projection optical apparatus projects the image light, and a control section that controls the optical path shifter, and the control section acquires the result of detection performed by the vibration detection sensor, generates a vibration waveform having a phase opposite the phase of the waveform of the vibration based on the acquired detection result, generates a drive waveform that approximates to the vibration waveform having the opposite phase, and drives the optical path shifter based on the generated drive waveform.

The present application is based on, and claims priority from JP Application Serial Number 2023-051524, filed Mar. 28, 2023, the disclosure of which is hereby incorporated by reference herein in its entirety.

### BACKGROUND

### 1. Technical Field

The present disclosure relates to a projector and a control apparatus.

### 2. Related Art

There is a known projector including an optical path deflector that changes the projection direction in which a projection system projects image light, a vibration detector that detects vibration, and an optical path deflection controller that controls the amount by which the optical path deflector changes the projection direction based on the vibration detected by the vibration detector (see JP-A-2017-191274, for example).

In the projector described in JP-A-2017-191274, the optical path deflector is an element that deflects the travel direction of the image light projected onto a projection receiving surface, and a horizontal driver and a vertical driver drive the optical path deflector to change the amount of change in the projection direction of the image light deflected by the optical path deflector.

When the detected vibration is greater than or equal to a first threshold, the optical path deflection controller controls the drivers in such a way that the image light projected by the projector moves to a position where the vibration acting on the projector is canceled out. Image blurs at the projection receiving surface are thus suppressed.

When the detected vibration is smaller than the first threshold, the optical path deflection controller controls the drivers in such a way that the projector projects the image light at high resolution. For example, the optical path deflection controller effectively increases the number of vertical and horizontal pixels of the image to increase the resolution of the projected image by controlling the operation of the horizontal and vertical drivers in such a way that the following two states are alternately repeated: a state in which the image light is projected with the optical path not deflected; and a state in which the image light is projected with the pixels horizontally and vertically shifted by half the pixel interval.

JP-A-2017-191274 is an example of the related art.

However, when the detected vibration is greater than or equal to the first threshold, the projector described in JP-A-2017-191274 suppresses the vibration but does not increase the resolution of the image. The projector described in JP-A-2017-191274 is therefore capable of suppressing the image blur caused by the vibration but incapable of increasing the image resolution at the same time.

### SUMMARY

A projector according to a first aspect of the present disclosure includes an image formation apparatus that forms image light from illumination light that enters the image formation apparatus, a projection optical apparatus that projects the image light formed by the image formation apparatus, an optical path shifter that is disposed in an optical path of the image light between the image formation apparatus and the projection optical apparatus and shifts the optical path of the image light with respect to a reference position where the image light is projected, a vibration detection sensor that detects vibration that affects the position where the projection optical apparatus projects the image light, and a control section that controls the optical path shifter, the control section acquiring a result of detection performed by the vibration detection sensor, generating a vibration waveform having a phase opposite a phase of a waveform of the vibration based on the acquired detection result, generating a drive waveform that approximates to the vibration waveform having the opposite phase, and driving the optical path shifter based on the generated drive waveform.

A control apparatus according to a second aspect of the present disclosure is a control apparatus that controls an optical path shifter of a projector including an image formation apparatus that forms image light from illumination light that enters the image formation apparatus, a projection optical apparatus that projects the image light formed by the image formation apparatus, the optical path shifter disposed in an optical path of the image light between the image formation apparatus and the projection optical apparatus and shifting the optical path of the image light with respect to a reference position where the image light is projected, and a vibration detection sensor that detects vibration that affects the position where the projection optical apparatus projects the image light, wherein the control apparatus acquiring a result of detection performed by the vibration detection sensor, generating a vibration waveform having a phase opposite a phase of a waveform of the vibration based on the acquired detection result, generating a drive waveform that approximates to the vibration waveform having the opposite phase, and driving the optical path shifter based on the generated drive waveform.

### BRIEF DESCRIPTION OF THE DRAWINGS

FIG. 1 is a diagrammatic view showing a schematic configuration of a projector according to a first embodiment.

FIG. 2 shows an optical path shifter according to the first embodiment.

FIG. 3 describes optical path shift performed by the optical path shifter according to the first embodiment.

FIG. 4 is a block diagram showing another configuration of the projector according to the first embodiment.

FIG. 5 shows a drive waveform according to the first embodiment.

FIG. 6 shows another drive waveform according to the first embodiment.

FIG. 7 shows another drive waveform according to the first embodiment.

FIG. 8 describes a shift operation control process carried out by a control apparatus according to the first embodiment.

FIG. 9 shows the optical path shifter according to a second embodiment.

FIG. 10 describes the optical path shift performed by the optical path shifter according to the second embodiment.

FIG. 11 shows first and second drive waveforms according to the second embodiment.

FIG. 12 shows other first and second drive waveforms according to the second embodiment.

FIG. 13 shows other first and second drive waveforms according to the second embodiment.

### DESCRIPTION OF EMBODIMENTS

### First Embodiment

A first embodiment of the present disclosure will be described below with reference to the drawings.

### Schematic Configuration of Projector

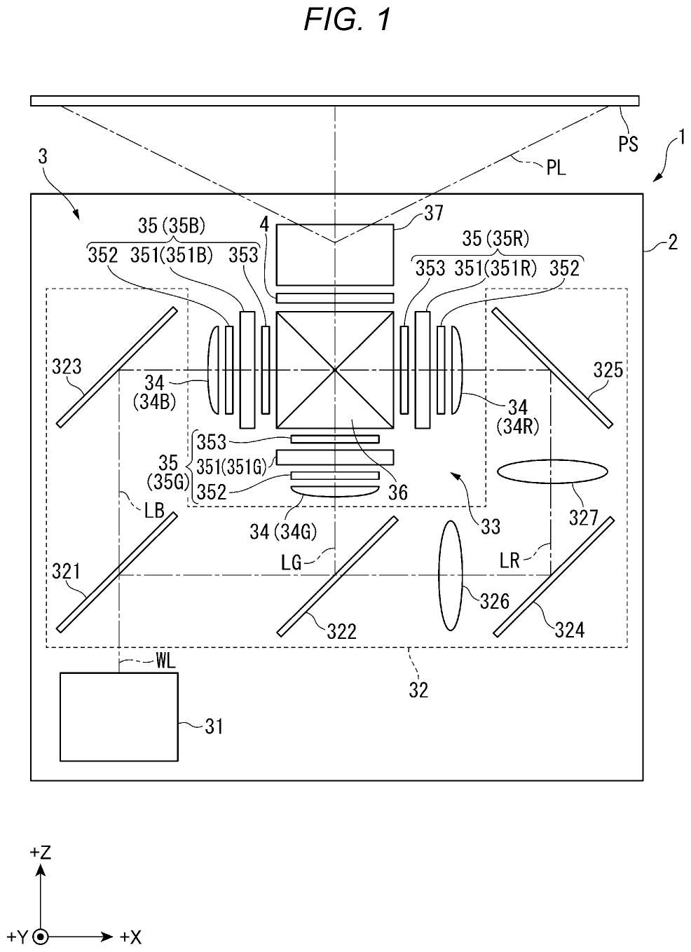

FIG. 1 is a diagrammatic view showing a schematic configuration of a projector 1 according to the present embodiment.

The projector 1 according to the present embodiment modulates light output from an illuminator 31 to form image light PL according to image information, enlarges the formed image light PL, and projects the enlarged image light PL onto a projection receiving surface PS, such as a screen, as shown in FIG. 1. The projector 1 includes an exterior enclosure 2, and an image projection unit 3 housed in the exterior enclosure 2. In addition to the components described above, the projector 1 includes, although not shown, a cooler that cools cooling targets, and a power supply that supplies electronic parts that constitute the projector 1 with electric power.

### Configuration of Image Projection Unit

The image projection unit 3 forms and projects the image light PL. The image projection unit 3 includes the illuminator 31, a color separator 32, an image formation apparatus 33, a projection optical apparatus 37, and an optical path shifter 4.

It is assumed in the following description that the direction in which the illuminator 31 outputs illumination light WL is a Z direction toward the positive end thereof, and that the directions perpendicular to the Z direction toward the positive end thereof are an X direction and a Y direction toward the positive ends thereof. It is further assumed that the opposite direction of the Z direction toward the positive end thereof is a Z direction toward the negative end thereof, that the opposite direction of the X direction toward the positive end thereof is an X direction toward the negative end thereof, and that the opposite direction of the Y direction toward the positive end thereof is a Y direction toward the negative end thereof. It is still further assumed that an axis along the Z direction toward the positive end thereof is a Z-axis, that the axis along the X direction toward the positive end thereof is an X-axis, and that the axis along the Y direction toward the positive end thereof is a Y-axis.

### Configuration of Illuminator

The illuminator 31 outputs the illumination light WL toward the positive end of the Z direction. The configuration of the illuminator 31 may, for example, include a solid-state light emitter and a wavelength converter that converts the wavelength of the light emitted from the solid-state light emitter. The configuration of the illuminator 31 may instead, for example, include a discharge-type light emitting lamp, such as an ultrahigh-pressure mercury lamp.

### Configuration of Color Separator

The color separator 32 separates the illumination light WL incident from the illuminator 31 into three kinds of color light, blue light LB, green light LG, and red light LR. The color separator 32 includes dichroic mirrors 321 and 322, total reflection mirrors 323, 324, and 325, and relay lenses 326 and 327.

Out of the illumination light WL incident from the illuminator 31, the dichroic mirror 321 transmits the blue light LB and reflects the green light LG and the red light LR toward the positive end of the X direction.

Out of the green light LG and the red light LR separated by the dichroic mirror 321, the dichroic mirror 322 reflects the green light LG toward the positive end of the Z direction, and transmits the red light LR toward the positive end of the X direction. The green light LG reflected off the dichroic mirror 322 enters a green light modulation module 35G provided in the image formation apparatus 33.

The total reflection mirror 323 reflects the blue light LB having passed through the dichroic mirror 321 toward the positive end of the X direction. The blue light LB reflected off the total reflection mirror 323 enters a blue light modulation module 35B provided in the image formation apparatus 33.

The total reflection mirror 324 reflects the red light LR having passed through the dichroic mirror 322 toward the positive end of the Z direction.

The total reflection mirror 325 reflects the red light LR reflected off the total reflection mirror 324 toward the negative end of the X direction. The red light LR reflected off the total reflection mirror 325 enters a red light modulation module 35R provided in the image formation apparatus 33.

The relay lens 326 is disposed between the dichroic mirror 322 and the total reflection mirror 324 in the optical path of red light LR, and the relay lens 327 is disposed between the total reflection mirror 324 and the total reflection mirror 325 in the optical path of red light LR. The relay lenses 326 and 327 compensate for the optical loss of the red light LR due to the fact that the optical path of the red light LR is longer than the optical path of blue light LB and the optical path of green light LG.

### Configuration of Image Formation Apparatus

The image formation apparatus 33 separately modulates the incident blue light LB, green light LG, and red light LR, and combines the modulated color light LB, color light LG, and color light LR with one another to form the image light PL to be projected by the projection optical apparatus 37. The image formation apparatus 33 includes field lenses 34, the light modulation modules 35, and a light combiner 36.

### Configuration of Field Lenses

The field lenses 34 each parallelize the light incident thereon. The image formation apparatus 33 includes three field lenses 34. The three field lenses 34 include a field lens 34B provided in the optical path of the blue light LB, a field lens 34G provided in the optical path of the green light LG, and a field lens 34R provided in the optical path of the red light LR. The color light LR having passed through the field lens 34R enters the light modulation module 35 dedicated for the color light, so do the color light LG having passed through the field lens 34G, and the color light LB having passed through the field lens 34B.

### Configuration of Light Modulation Modules

The light modulation modules 35 each modulate color light incident thereon to form image light according to image information, and outputs the formed image light to the light combiner 36. The image formation apparatus 33 includes three light modulation modules 35. The three light modulation modules 35 include the blue light modulation module 35B, which modulates the blue light LB and outputs blue image light, the green light modulation module 35G, which modulates the green light LG and outputs green image light, and the red light modulation module 35R, which modulates the red light LR and outputs red image light.

The light modulation modules 35 each include a light modulator 351, a light-incident-side polarizer 352, and a light-exiting-side polarizer 353.

Specifically, the blue light modulation module 35B includes a blue light modulator 351B, which modulates the blue light LB, the light-incident-side polarizer 352, which is disposed on the light incident side of the blue light modulator 351B, and the light-exiting-side polarizer 353, which is disposed on the light exiting side of the blue light modulator 351B. The blue light modulation module 35B outputs the blue image light toward the positive end of the X direction.

The green light modulation module 35G includes a green light modulator 351G, which modulates the green light LG, the light-incident-side polarizer 352, and the light-exiting-side polarizer 353. The green light modulation module 35G outputs the green image light toward the positive end of the Z direction.

The red light modulation module 35R includes a red light modulator 351R, which modulates the red light LR, the light-incident-side polarizer 352, and the light-exiting-side polarizer 353. The red light modulation module 35R outputs the red image light toward the negative end of the X direction.

In the present embodiment, the light modulators 351 are each formed of a liquid crystal panel, and the light modulation modules 35 are each a liquid crystal light valve including the light modulator 351, the light-incident-side polarizer 352, and the light-exiting-side polarizer 353.

### Configuration of Light Combiner

The light combiner 36 combines the blue image light incident from the blue light modulation module 35B, the green image light incident from the green light modulation module 35G, and the red image light incident from the red light modulation module 35R with one another to form the image light PL, and outputs the formed image light PL toward the optical path shifter 4. That is, the light combiner 36 outputs the formed image light PL toward the projection optical apparatus 37.

In the present embodiment, the light combiner 36 is formed of a cross dichroic prism having a substantially cuboidal shape, but not necessarily. The light combiner 36 may be formed, for example, of a plurality of dichroic mirrors.

### Configuration of Projection Optical Apparatus

The projection optical apparatus 37 projects the image light PL incident from the light combiner 36 of the image formation apparatus 33 via the optical path shifter 4 onto the projection receiving surface PS. Although not shown, the projection optical apparatus 37 can, for example, be a unit lens including a plurality of lenses and a lens barrel that holds the plurality of lenses.

In the present specification, note that an image formed by the image light PL projected by the projection optical apparatus 37 and displayed on the projection receiving surface PS is called a projected image.

### Configuration of Optical Path Shifter

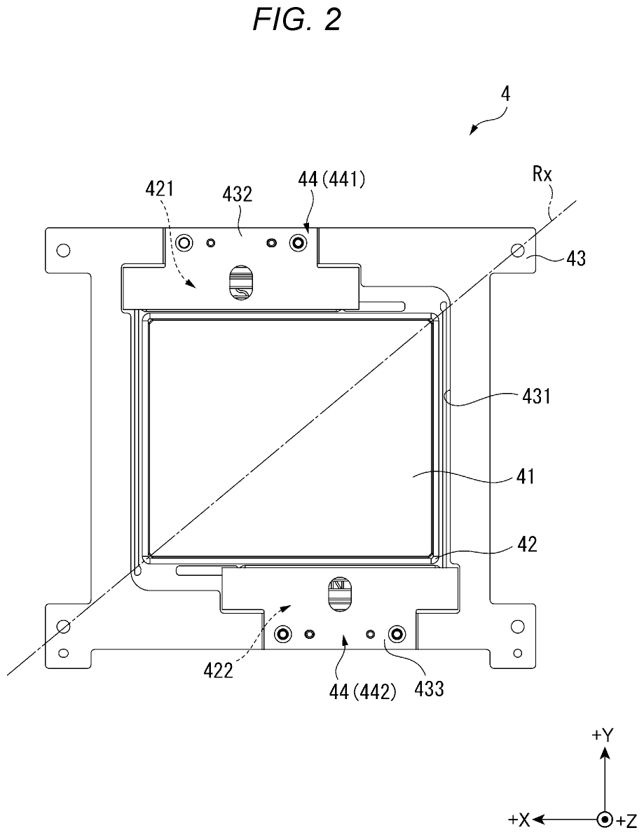

FIG. 2 shows the optical path shifter 4 viewed from the light exiting side.

The optical path shifter 4 shifts the optical path of the image light having entered the optical path shifter 4. The optical path shifter 4 includes an optical path changing member 41, a holding member 42, a base 43, and a driver 44, as shown in FIG. 2.

The optical path changing member 41 is formed of a light transmissive member that can transmit the image light. The optical path changing member 41 is formed, for example, of a glass plate.

### Configuration of Holding Member

The holding member 42 is a frame-shaped member that holds the optical path changing member 41 and magnets of the driver 44.

The holding member 42 includes a first fixing section 421, to which a magnet that constitutes a first actuator 441 of the driver 44 is fixed, and a second fixing section 422, to which a magnet that constitutes a second actuator 442 of the driver 44 is fixed.

The first fixing section 421 is provided at a portion that forms the holding member 42 and is shifted toward the positive ends of the X and Y directions when viewed from the positive end of the Z direction, and the second fixing section 422 is provided at a portion that forms the holding member 42 and is shifted toward the negative ends of the X and Y directions when viewed from the positive end of the Z direction.

### Configuration of Base

The base 43 is a frame-shaped member that supports the holding member 42 swingably around a swing axis Rx. The base 43 has an opening 431, in which the holding member 42 is disposed.

The base 43 includes a first support 432, which supports a coil that constitutes the first actuator 441 of the driver 44, and a second support 433, which supports a coil that constitutes the second actuator 442 of the driver 44.

The first support 432 is provided at a portion that forms the base 43 and is shifted toward the positive ends of the X and Y directions when viewed from the positive end of the Z direction, and the second support 433 is provided at a portion that forms the base 43 and is shifted toward the negative ends of the X and Y directions when viewed from the positive end of the Z direction.

### Configuration of Driver

The driver 44 swings the holding member 42, which holds the optical path changing member 41, around the swing axis Rx to swing the optical path changing member 41 around the swing axis Rx relative to the base 43. The driver 44 includes the first actuator 441, which is provided at a position shifted from the optical path changing member 41 toward the positive ends of the X and Y directions, and the second actuator 442, which is provided at a position shifted from the optical path changing member 41 toward the negative ends of the X and Y directions.

The first actuator 441 is a voice coil motor including a magnet fixed to the first fixing section 421 of the holding member 42 and a coil supported by the first support 432 of the base 43.

The second actuator 442 is a voice coil motor including a magnet fixed to the second fixing section 422 of the holding member 42 and a coil supported by the second support 433 of the base 43.

A control apparatus 6, which will be described later, supplies the coil of the first actuator 441 and the coil of the second actuator 442 with AC currents that are opposite in phase to each other to swing the optical path changing member 41 held by the holding member 42 around the swing axis Rx.

In the optical path shifter 4, the swing axis Rx of the optical path changing member 41 is perpendicular to the Z-axis and extends in a direction that intersects with each of the X-axis and the Y-axis.

Specifically, the intersection angle between the swing axis Rx and the X-axis is equal to the intersection angle between the diagonal of an image having an aspect ratio of 16:9 and the horizontal direction of the image, and the intersection angle between the swing axis Rx and the Y-axis is equal to the intersection angle between the diagonal of the image having the aspect ratio of 16:9 and the vertical direction of the image, but not necessarily. For example, the intersection angle between the swing axis Rx and the X-axis and the intersection angle between the swing axis Rx and the Y-axis may each be 45°.

### Optical Path Shift Performed by Optical Path Shifter

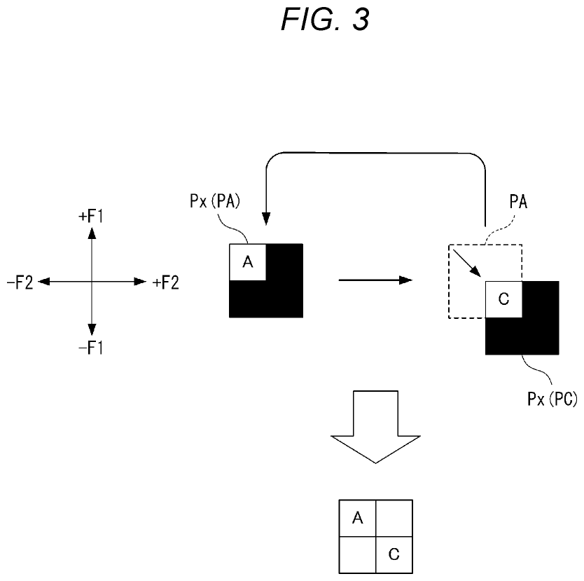

FIG. 3 describes shifts of the optical path of the image light performed by the optical path shifter 4.

An increase in the resolution of the projected image achieved by the optical path shifter 4 will now be described.

As described above, the optical path shifter 4 changes the posture of the optical path changing member 41, through which the image light PL passes, to shift the optical path of the image light PL with the aid of refraction that occurs at the optical path changing member 41.

Note that an F1 direction toward the positive end thereof and an F2 direction toward the positive end thereof shown in FIG. 3 are directions perpendicular to each other at the projection receiving surface PS, that an F1 direction toward the negative end thereof is the opposite direction of the F1 direction toward the positive end thereof, and that an F2 direction toward the negative end thereof is the opposite direction of the F2 direction toward the positive end thereof.

Specifically, the optical path shifter 4 shifts the optical path of the image light in the direction perpendicular to the swing axis Rx when viewed from the side at which the image light is incident on the optical path shifter 4 by swinging the optical path changing member 41 around the swing axis Rx. A pixel Px of the projected image displayed on the projection receiving surface PS is therefore displaced in the F1 direction toward the positive end thereof and the F2 direction toward the negative end thereof, in which the pixel Px is shifted to a position PA, and in the F1 direction toward the negative end thereof and the F2 direction toward the positive end thereof, in which the pixel Px is shifted to a position PC, as shown in FIG. 3.

The control apparatus 6, which will be described later, causes the optical path shifter 4 to combine the pixel shift toward the positive end of the F1 direction and the negative end of the F2 direction and the pixel shift toward the negative end of the F1 direction and the positive end of the F2 direction with each other to increase the apparent number of pixels and hence increase the resolution of the projected image.

For example, the control apparatus 6 causes the optical path shifter 4 to shift the optical path of the image light to move the pixel Px to a position displaced by half a pixel toward the negative end of the F1 direction and toward the positive end of the F2 direction. The term “half a pixel” indicates half of the size of the pixel Px.

The position where the pixel Px is displayed on the projection receiving surface PS is thus shifted from the position PA, which is a reference position, to the position PC, which is the position shifted from the position PA by a half pixel toward the negative end of the F1 direction and the positive end of the F2 direction.

The control apparatus 6 thus causes the optical path shifter 4 to shift the optical path of the image light PL in such a way that the pixel Px is displayed at each of the positions PA and PC for a fixed period of time to change the contents displayed by the light modulation modules 35R, 35G, and 35B in synchronization with the optical path shift. Pixels A and C each having a size apparently smaller than the size of the pixel Px can thus be displayed.

For example, to display the pixels A and C as a whole at a frequency of 60 Hz, the contents displayed by the light modulators 351R, 351G, and 351B need to be switched to other contents at the frequency twice higher than 60 Hz in correspondence with the positions PA and PC. In this case, a projected image having an apparently higher resolution can be displayed by setting the refresh rate of each of the light modulators 351 at 120 Hz and causing the light modulator 351 to successively form image light containing the pixel A displayed at the position PA and image light containing the pixel C displayed at the position PC.

In the example of the pixel shift shown in FIG. 3, the F1 directions toward the positive and negative ends thereof and the F2 directions toward the positive and negative ends thereof are the directions in which the pixels Px displayed in a matrix on the projection receiving surface PS are arranged. The directions in which the optical path changing member 41 is swung around the swing axis Rx to move the pixels Px are the F1 direction toward the negative end thereof and the direction F2 toward the positive end thereof, and the direction F1 toward the positive end thereof and the direction F2 toward the negative end thereof, which all intersect each of the direction F1 toward the positive end thereof and the direction F2 toward the positive end thereof. Swinging the optical path changing member 41 around the swing axis Rx can therefore move each of the pixels Px to each of the positions PA and PC.

Note that the amount of displacement of the position PC from the position PA is not limited to half a pixel, and may, for example, be ¼ or ¾ of the pixel Px.

### Another Configuration of Projector

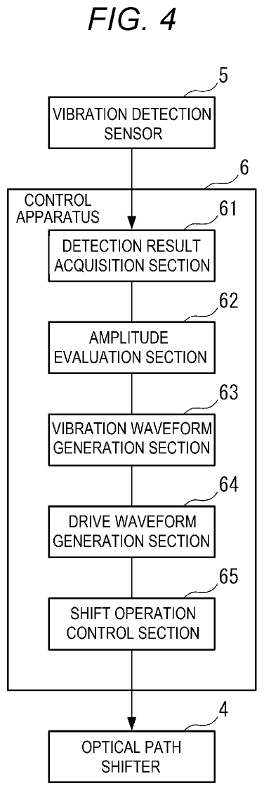

FIG. 4 is a block diagram showing another configuration of the projector 1.

The projector 1 further includes a vibration detection sensor 5 and the control apparatus 6, as shown in FIG. 4.

The optical path shifter 4 improves the resolution of the projected image in a pseudo manner, as described above. On the other hand, when any vibration that affects the position of the projected image acts on the projector 1, the projected image undesirably swings on the projection receiving surface PS. When the frequency of the swing motion of the projected image is lower than or equal to 40 Hz, in particular, an observer is likely to recognize the swing motion of the projected image. To avoid the situation described above, the control apparatus 6 operates the optical path shifter 4 to suppress the swing motion of the projected image at the projection receiving surface PS based on the waveform of the vibration detected by the vibration detection sensor 5.

The configurations of the vibration detection sensor 5 and the control apparatus 6 will be described below in detail.

### Configuration of Vibration Detection Sensor

The vibration detection sensor 5 detects vibration that affects the position where the projection optical apparatus 37 projects the image light PL. In detail, the vibration detection sensor 5 detects the amount of displacement of vibration in the direction perpendicular to the Z-axis and the swing axis Rx out of the vibration acting on the projector 1. The vibration detection sensor 5 outputs a detection signal representing the detected vibration to the control apparatus 6. Examples of the vibration detection sensor 5 described above may include an acceleration sensor and a gyro sensor.

The position where the vibration detection sensor 5 is disposed may, for example, be the front end of the projection optical apparatus 37.

### Configuration of Control Apparatus

The control apparatus 6 is a control section that controls the operation of the projector 1. For example, the control apparatus 6 controls turning on and off the illuminator 31, and causes each of the light modulators 351 to form image light according to an image signal based on the incident illumination light.

Furthermore, the control apparatus 6 controls the optical path shifter 4 to cause the optical path shifter 4 to shift the optical path of the image light PL as described above. In this process, the control apparatus 6 causes the optical path shifter 4 to shift the image light in a direction in which the swing motion of the projected image caused by the vibration is suppressed at the projection receiving surface PS based on the result of the detection performed by the vibration detection sensor 5. That is, the control apparatus 6 controls the operation of the optical path shifter 4 to cause the optical path shifter 4 to function not only as an optical path shifter that improves the resolution of the projected image, but also as a vibration suppresser that suppresses vibration of the projected image at the projection receiving surface.

To operate the optical path shifter 4 as described above, the control apparatus 6 includes a detection result acquisition section 61, an amplitude evaluation section 62, a vibration waveform generation section 63, a drive waveform generation section 64, and a shift operation control section 65.

The detection result acquisition section 61 acquires the result of the detection performed by the vibration detection sensor 5. That is, the detection result acquisition section 61 acquires the vibration detection single output from the vibration detection sensor 5.

The amplitude evaluation section 62 evaluates whether the amplitude of the vibration is greater than or equal to a predetermined threshold based on the amount of displacement of the vibration detected by the vibration detection sensor 5.

The vibration waveform generation section 63 generates the waveform of the vibration detected by the vibration detection sensor 5 based on the detection signal input from the vibration detection sensor 5. That is, the vibration waveform generation section 63 generates the waveform of the vibration that affects the position where the image light is projected based on the result of the detection performed by the vibration detection sensor 5. In detail, the vibration waveform generation section 63 generates the waveform of the vibration in the direction perpendicular to the Z-axis and the swing axis Rx. The vibration waveform generation section 63 then generates the waveform of the vibration opposite in phase to the generated vibration. Note that the vibration waveform having the opposite phase is a waveform having a phase opposite the phase of a predicted waveform of the vibration based on the result of the detection performed by the vibration detection sensor 5, and is a waveform that suppresses the detected vibration. The vibration waveform having the opposite phase is hereinafter referred to as a vibration suppression waveform.

The drive waveform generation section 64 generates a drive waveform used to operate the optical path shifter 4. Specifically, when the amplitude of the detected vibration is determined by the amplitude evaluation section 62 to be smaller than the predetermined threshold, the drive waveform generation section 64 generates a waveform that is used to drive the optical path shifter 4 and improves the resolution of the projected image in a pseudo manner. On the other hand, when the amplitude of the detected vibration is determined by the amplitude evaluation section 62 to be greater than or equal to the predetermined threshold, the drive waveform generation section 64 generates a waveform that is used to drive the optical path shifter 4 and improves the resolution of the projected image in a pseudo manner and suppresses the swing motion of the projected image at the projection receiving surface PS.

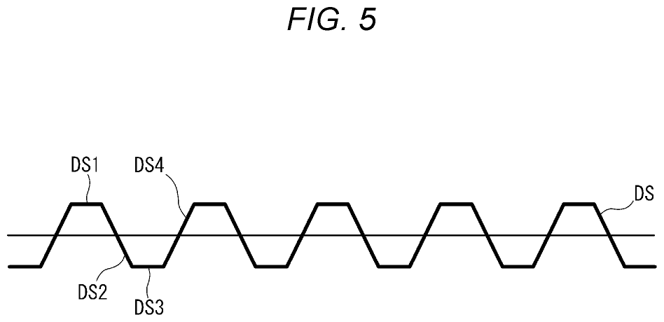

FIG. 5 shows a drive waveform DS generated when the amplitude of the vibration is smaller than than the predetermined threshold.

When the amplitude of the vibration is smaller than the predetermined threshold, the drive waveform generation section 64 generates the drive waveform DS shown in FIG. 5, which is a trapezoidal waveform. The drive waveform DS is a trapezoidal waveform having a top portion DS1, a gradually decreasing portion DS2, a bottom portion DS3, and a gradually increasing portion DS4, which together constitute one cycle.

The top portion DS1 is a portion where the voltage value is set at the positive pole side and maintained substantially constant. During the period of the top portion DS1, the optical path changing member 41 is halted and remains displaced.

The bottom portion DS3 is a portion where the voltage value is set at the negative pole side and maintained substantially constant. During the period of the bottom portion DS3, the optical path changing member 41 is halted and remains displaced.

The gradually decreasing portion DS2 is a portion which links the end of the top portion DS1 to the start of the bottom portion DS3 and where the voltage value continuously and gradually decreases. During the period of the gradually decreasing portion DS2, the driver 44 is driven to displace the optical path changing member 41.

The gradually increasing portion DS4 is portion which links the end of the bottom portion DS3 to the start of the top portion DS1 and where the voltage value continuously and gradually increases. During the period of the gradually increasing portion DS4, the driver 44 is driven to displace the optical path changing member 41 in the opposite direction of the direction in which the optical path changing member 41 is swung at the gradually decreasing portion DS2.

The frequency of the drive waveform DS can be equal to the frequency of the refresh rate of the light modulators 351. For example, when the refresh rate of the light modulators 351 is 120 Hz, the frequency of the drive waveform DS can be 120 Hz.

Based on the thus set drive waveform DS, the shift operation control section 65 operates the driver 44 of the optical path shifter 4 to cause the optical path changing member 41 to swing around the swing axis Rx, so that the image including the pixel A displayed at the position PA described above and the image including the pixel C displayed at the position PC described above can be displayed at 60 Hz.

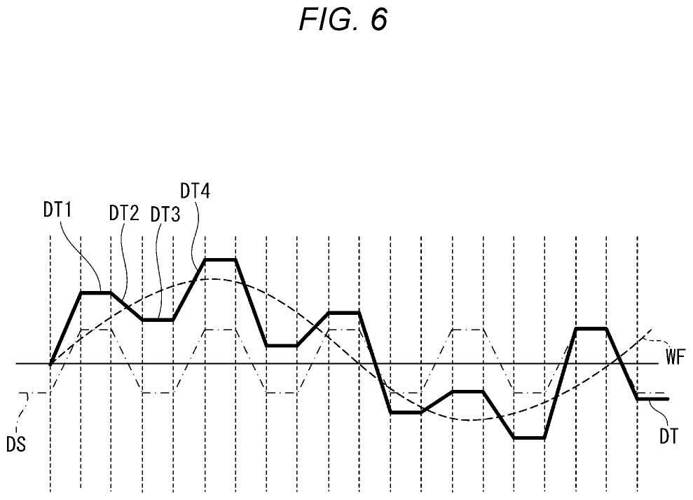

FIG. 6 shows a vibration suppression waveform WF and a drive waveform DT generated when the amplitude of the vibration is greater than or equal to the predetermined threshold. FIG. 6 shows the drive waveform DS drawn by the chain line.

When the amplitude of the vibration is determined by the amplitude evaluation section 62 to be greater than or equal to the predetermined threshold, the drive waveform generation section 64 generates the drive waveform DT in accordance with the vibration suppression waveform WF, as shown in FIG. 6. The drive waveform DT is a trapezoidal waveform used to operate the optical path shifter 4 and is a waveform resulting from approximation of the drive waveform DS to the vibration suppression waveform WF. In detail, the drive waveform DT is a waveform resulting from approximation of the drive waveform DS to the vibration suppression waveform WF in terms of the positions of the top portion DS1 and the bottom portion DS3.

Specifically, the drive waveform DT is a trapezoidal waveform having a top portion DT1, a gradually decreasing portion DT2, a bottom portion DT3, and a gradually increasing portion DT4, which together constitute one cycle, as the drive waveform DS is.

The top portion DT1 is the portion where the voltage value is maintained substantially constant, approximates to the amount of displacement of the vibration suppression waveform WF corresponding to the top portion DT1, and has a potential set to be higher than that of the vibration suppression waveform WF. During the period of the top portion DT1, the optical path changing member 41 is halted and remains displaced.

The bottom portion DT3 is the portion where the voltage value is maintained substantially constant, approximates to the amount of displacement of the vibration suppression waveform WF corresponding to the bottom portion DT3, and has a potential set to be lower than that of the vibration suppression waveform WF. That is, the potential of the bottom portion DT3 is lower than that of the top portion DT1. During the period of the bottom portion DT3, the optical path changing member 41 is halted and remains displaced.

The gradually decreasing portion DT2 is a portion which links the end of the top portion DT1 to the start of the bottom portion DT3 and where the voltage value continuously and gradually decreases. During the period of the gradually decreasing portion DT2, the driver 44 is driven to displace the optical path changing member 41.

The gradually increasing portion DT4 is a portion which links the end of the bottom portion DT3 to the start of the top portion DT1 and where the voltage value continuously and gradually increases. During the period of the gradually increasing portion DT4, the driver 44 is driven to displace the optical path changing member 41 in the opposite direction of the direction in which the optical path changing member 41 is swung at the gradually decreasing portion DT2.

The frequency of the drive waveform DT is equal to the frequency of the drive waveform DS.

The drive waveform generation section 64 generates the drive waveform DT as described below.

When the amplitude of the vibration detected by the vibration detection sensor 5 is smaller than the predetermined threshold, the drive waveform generation section 64 generates the drive waveform DS shown in FIG. 5.

On the other hand, when the amplitude of the vibration detected by the vibration detection sensor 5 is greater than or equal to the predetermined threshold, the drive waveform generation section 64 calculates the amounts of displacement of the vibration suppression waveform WF corresponding to the centers of the top portion DT1 and the bottom portion DT3 of the drive waveform DT based on the vibration suppression waveform WF generated by the vibration waveform generation section 63. The drive waveform generation section 64 calculates the potential of each of the top portion DT1 and the bottom portion DT3 based on the calculated amount of displacement. The drive waveform generation section 64 sets the potential of the top portion DT1 to be higher than the potential of the vibration suppression waveform WF, and sets the potential of the bottom portion DT3 to be lower than the potential of the vibration suppression waveform WF. Note that the potentials are set based on predetermined coefficients. The period of the top portion DT1 is equal to the period of the top portion DS1, and the period of the bottom portion DT3 is equal to the period of the bottom portion DS3. The drive waveform generation section 64 generates the gradually decreasing portion DT2, which couples the end of the top portion DT1 to the start of the bottom portion DT3, and further generates the gradually increasing portion DT4, which couples the end of the bottom portion DT3 to the start of the top portion DT1. A waveform that approximates to a vibration waveform having the opposite polarity is thus generated as the trapezoidal waveform used to perform the shift operation.

Note that noise of the actuators 441 and 442, which constitute the driver 44, can be lowered by roundly chamfering each of the corner where the top portion DT1 is coupled to the gradually decreasing portion DT2, the corner where the gradually decreasing portion DT2 is coupled to the bottom portion DT3, the corner where the bottom portion DT3 is coupled to the gradually increasing portion DT4, and the corner where the gradually increasing portion DT4 is coupled to the top portion DT1.

As described above, the one cycle of the drive waveform DT approximates to the vibration suppression waveform WF in the period corresponding to the one cycle of the drive waveform DT, and the positions of the top portion DT1 and the bottom portion DT3 each approximate to the corresponding amount of displacement of the vibration suppression waveform WF. That is, the average voltage value of one cycle of the drive waveform DT correlates to the average amount of displacement caused by the vibration suppression waveform WF in the period corresponding to one cycle of the drive waveform DT.

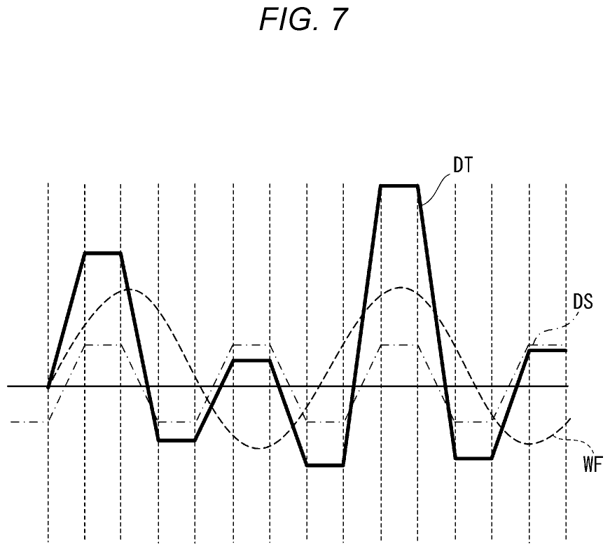

FIG. 7 shows the vibration suppression waveform WF and the drive waveform DT generated when vibration having a frequency different from that in the example in FIG. 6 acts. FIG. 7 shows the drive waveform DS drawn by the chain line.

Even when vibration having a frequency different from that used to generate the vibration suppression waveform WF shown in FIG. 6 is detected, the vibration suppression waveform WF corresponding to the waveform of the detected vibration is generated by the vibration waveform generation section 63, as shown in FIG. 7. The drive waveform generation section 64 generates the drive waveform DT according to the generated vibration suppression waveform WF. The frequency of the thus generated drive waveform DT is also equal to the frequency of the drive waveform DS described above.

The shift operation control section 65 operates the optical path shifter 4 based on the drive waveform DS or the drive waveform DT generated by the drive waveform generation section 64.

Specifically, when the amplitude of the vibration is determined by the amplitude evaluation section 62 to be smaller than the predetermined threshold, the drive waveform DS is generated by the drive waveform generation section 64, so that the shift operation control section 65 drives the optical path shifter 4 based on the generated drive waveform DS. The position of the projected image at the projection receiving surface PS is thus successively moved, so that the resolution of the projected image is improved in a pseudo manner.

On the other hand, when the amplitude of the vibration is determined by the amplitude evaluation section 62 to be greater than or equal to the predetermined threshold, the drive waveform DT is generated by the drive waveform generation section 64, so that the shift operation control section 65 drives the optical path shifter 4 based on the generated drive waveform DT. Therefore, the position of the projected image at the projection receiving surface PS is successively moved, and the resolution of the projected image at the projection receiving surface PS is improved in a pseudo manner with the swing motion of the projected image at the projection receiving surface PS suppressed.

### Shift Operation Control Process

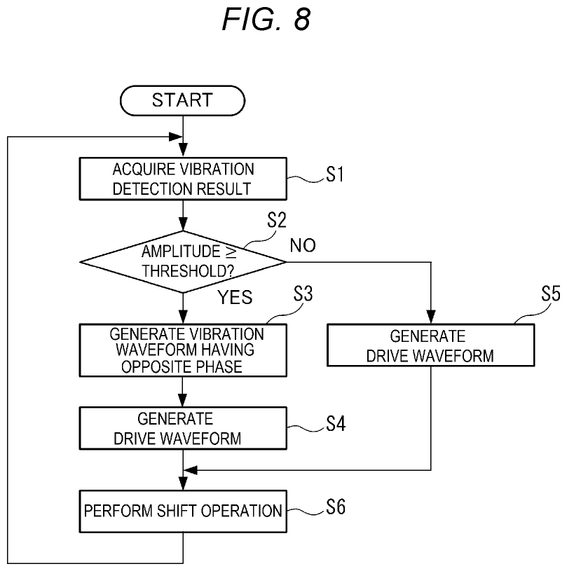

FIG. 8 describes a shift operation control process carried out by the control apparatus 6.

The control apparatus 6 carries out the shift operation control process shown in FIG. 8.

In the shift operation control process, the detection result acquisition section 61 first acquires the result of the detection performed by the vibration detection sensor 5 (step S1). That is, the detection result acquisition section 61 acquires the vibration detection single output from the vibration detection sensor 5 (step S1).

The amplitude evaluation section 62 then evaluates whether the amplitude of the detected vibration is greater than or equal to the predetermined threshold based on the acquired detection result (step S2).

When it is determined in the evaluation process in step S2 that the amplitude of the detected vibration is greater than or equal to the threshold (YES in step S2), the vibration waveform generation section 63 generates the vibration suppression waveform WF (step S3). The vibration suppression waveform WF is the vibration waveform having a phase opposite the phase of the detected vibration, as described above.

After step S3, the drive waveform generation section 64 generates the drive waveform DT based on the vibration suppression waveform WF (step S4). After step S4, the control apparatus 6 transitions to the process in step S6.

When it is determined in the evaluation process in step S2 that the amplitude of the detected vibration is smaller than the threshold (NO in step S2), the drive waveform generation section 64 generates the drive waveform DS (step S5). After step S5, the control apparatus 6 transitions to the process in step S6.

In step S6, the shift operation control section 65 drives the optical path shifter 4 based on the generated drive waveform DS or drive waveform DT (step S6).

After step S6, the control apparatus 6 returns to the process in step S1. The shift operation control process is thus repeatedly carried out.

### Effects of First Embodiment

The projector 1 according to the present embodiment described above provides the effects below.

The projector 1 includes the image formation apparatus 33, the projection optical apparatus 37, the optical path shifter 4, the vibration detection sensor 5, and the control apparatus 6.

The image formation apparatus 33 forms the image light PL from the illumination light WL incident from the illuminator 31. The projection optical apparatus 37 projects the image light PL formed by the image formation apparatus 33.

The optical path shifter 4 is disposed in the optical path of the image light PL between the image formation apparatus 33 and the projection optical apparatus 37. The optical path shifter 4 shifts the optical path of the image light PL with respect to the reference position where the image light PL is projected.

The vibration detection sensor 5 detects vibration that affects the position where the projection optical apparatus 37 projects the image light PL.

The control apparatus 6 corresponds to a control section and controls the optical path shifter 4 of the projector 1.

The control apparatus 6 causes the detection result acquisition section 61 to acquire the result of the detection performed by the vibration detection sensor 5, and causes the vibration waveform generation section 63 to generate the vibration suppression waveform WF based on the acquired detection result. The vibration suppression waveform WF is the vibration waveform having a phase opposite the phase of the waveform of the vibration based on the detection result.

The control apparatus 6 causes the drive waveform generation section 64 to generate a drive waveform that approximates to the vibration suppression waveform WF, and causes the shift operation control section 65 to drive the optical path shifter 4 based on the generated drive waveform.

According to the configuration described above, the control apparatus 6 operates the optical path shifter 4 based on the drive waveform DT, which approximates to the vibration suppression waveform WF having a phase opposite the phase of the waveform of the detected vibration. Therefore, even when the image light PL swings due to the vibration, the resolution of the projected image can be improved in a pseudo manner with the swing motion of the projected image displayed on the projection receiving surface PS reduced. Reduction in the swing motion of the projected image and improvement in the resolution of the projected image in a pseudo manner can therefore be both achieved.

In the projector 1, the top portion DT1 of the drive waveform DT, which is a trapezoidal waveform, approximates to the amount of displacement of the vibration suppression waveform WF corresponding to the top portion DT1, and the bottom portion DT3 of the drive waveform DT approximates to the amount of displacement of the vibration suppression waveform WF corresponding to the bottom portion DT3.

According to the configuration described above, the optical path shifter 4 can be operated in accordance with the amount of displacement of the detected vibration. That is, the optical path shifter 4 can shift the image light PL in the opposite direction of the direction of the vibration in accordance with the amount of displacement of the projected image at the projection receiving surface PS due to the vibration. The swing motion of the projected image can therefore be further reduced.

In the projector 1, the potential of the top portion DT1 is set to be higher than the amount of displacement of the vibration suppression waveform WF corresponding to the top portion DT1, and the potential of the bottom portion DT3 is set to be lower than the amount of displacement of the vibration suppression waveform corresponding to the bottom portion DT3.

According to the configuration described above, the optical path shifter 4, which shifts the optical path of the image light by switching the voltage supplied thereto, can be operated in accordance with the vibration suppression waveform WF by setting the potential of the top portion DT1 of the drive waveform DT to be higher than the amount of displacement of the generated vibration suppression waveform WF and setting the potential of the bottom portion DT3 to be lower than the amount of displacement caused by the generated vibration suppression waveform WF. Therefore, when the resolution of the projected image is improved in a pseudo manner, the projected image displayed on the projection receiving surface PS can be moved in the opposite direction of the direction of the vibration in accordance with the amount of displacement of the projected image. The swing motion of the projected image at the projection receiving surface PS can therefore be effectively suppressed.

### Second Embodiment

A second embodiment of the present disclosure will next be described.

The projector according to the present embodiment has a configuration that is the same as that of the projector 1 according to the first embodiment but differs therefrom in that the optical path shifter has two swing axes of the optical path changing member. In the following description, portions that are the same or substantially the same as the portions having been already described have reference characters that are the same as those in the previous description and will not be described.

### Schematic Configuration of Projector

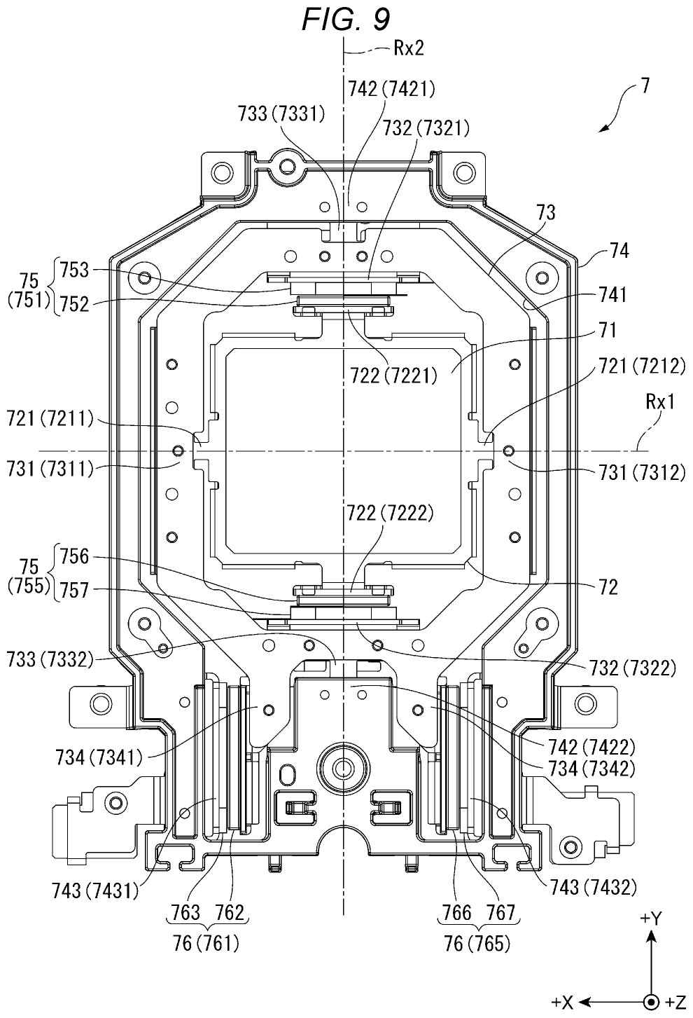

FIG. 9 shows an optical path shifter 7 provided in the projector according to the present embodiment viewed from the light exiting side.

The projector according to the present embodiment has a configuration and functions that are the same as those of the projector 1 according to the first embodiment except that the optical path shifter 4 is replaced with the optical path shifter 7 shown in FIG. 9. That is, the projector according to the present embodiment includes the exterior enclosure 2, the image projection unit 3, the vibration detection sensor 5, and the control apparatus 6, and the image projection unit 3 includes the optical path shifter 7 in place of the optical path shifter 4.

In the present embodiment, the vibration detection sensor 5 detects vibration in the direction in which the optical path of the image light shifts when a first driver 75 of the optical path shifter 7 is driven, and further detects vibration in the direction in which the optical path of the image light shifts when a second driver 76 of the optical path shifter 7 is driven. That is, the vibration detection sensor 5 detects vibration in the direction perpendicular to each of the Z-axis and a first swing axis Rx1, and further detects vibration in the direction perpendicular to each of the Z-axis and a second swing axis Rx2.

### Schematic Configuration of Optical Path Shifter

The optical path shifter 7 includes an optical path changing member 71, which is disposed between the light combiner 36 of the image formation apparatus 33 and the projection optical apparatus 37, as the optical path shifter 4 does. The optical path shifter 7 shifts the optical path of the image light PL, which is output from the light combiner 36 and enters the projection optical apparatus 37, to increase the resolution of the projected image formed by the image light PL in a pseudo manner.

The optical path changing member 71 is a light transmissive substrate, such as a glass substrate, as the optical path changing member 41 is. The optical path changing member 71 is disposed in the optical path of the image light PL between the light combiner 36 and the projection optical apparatus 37. The optical path changing member 71 is swung by the first driver 75, which will be described later, around the first swing axis Rx1 extending along the X-axis and further swung by the second driver 76, which will be described later, around the second swing axis Rx2 extending along the Y-axis. The thus configured optical path changing member 71 inclines with respect to a virtual plane perpendicular to the optical axis along which the light combiner 36 outputs the image light PL. The optical path changing member 71 thus shifts the optical path of the image light PL incident from the light combiner 36 with the aid of refraction. One of the first swing axis Rx1 and the second swing axis Rx2 corresponds to a first swing axis, and the other axis corresponds to a second swing axis.

### Optical Path Shift Performed by Optical Path Shifter

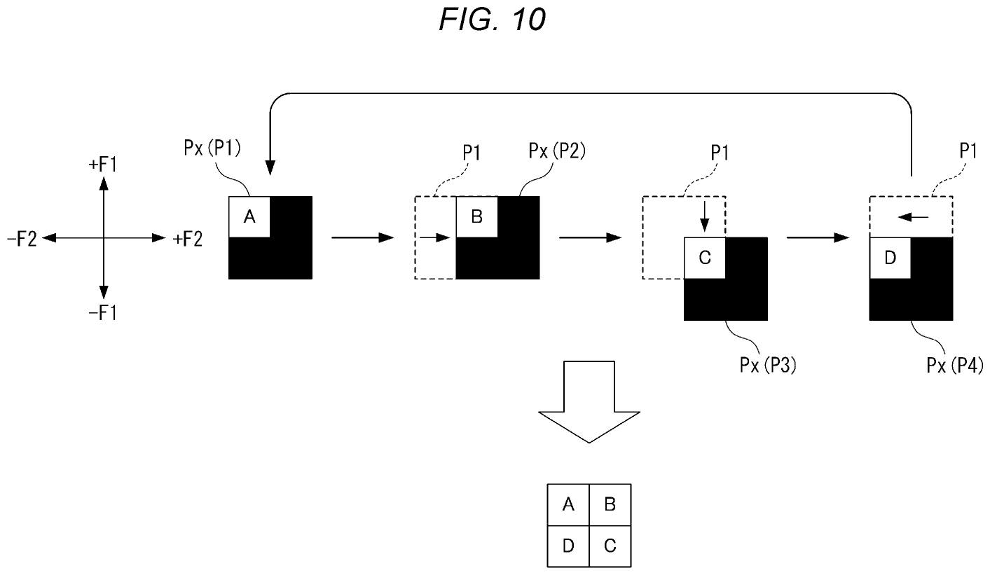

FIG. 10 describes the shift of the optical path of the image light performed by the optical path shifter 7.

The increase in the resolution of the projected image achieved by the optical path shifter 7 will now first be described.

The optical path shifter 7 changes the posture of the optical path changing member 71 to shift the optical path of the image light PL toward the positive and negative ends of the F1 direction and the positive and negative ends of the F2 direction, as shown in FIG. 10.

Note that the F1 direction toward the positive end thereof and the F2 direction toward the positive end thereof are directions perpendicular to each other along the projection receiving surface PS, that the F1 direction toward the negative end thereof is the opposite direction of the F1 direction toward the positive end thereof, and that the F2 direction toward the negative end thereof is the opposite direction of the F2 direction toward the positive end thereof, as in FIG. 3. For example, the F1 directions toward the positive and negative ends thereof are directions along the horizontal axis of the projected image, and the F2 directions toward the positive and negative ends thereof are directions along the vertical axis of the projected image, but not necessarily. The F1 directions toward the positive and negative ends thereof and the F2 directions toward the positive and negative ends thereof may not be perpendicular to each other, but may incline with respect to the directions in which the pixels Px are arranged.

The optical path shifter 7 shifts the optical path of the image light PL toward the positive and negative ends of the Y direction and toward the positive and negative ends of the X direction by swinging the optical path changing member 71 in two directions, a first swing direction around the first swing axis Rx1 and a second swing direction around the second swing axis Rx2. The pixels Px of the projected image displayed at the projection receiving surface PS are therefore displaced toward the positive and negative ends of the F1 direction and toward the positive and negative ends of the F2 direction, as shown in FIG. 10.

The control apparatus 6 causes the optical path shifter 7 to combine the pixel shift toward the positive and negative ends of the F1 direction and the pixel shift toward the positive and negative ends of the F2 direction with each other to increase the apparent number of pixels and hence increase the resolution of the projected image.

For example, the control apparatus 6 causes the optical path shifter 7 to shift the optical path of the image light PL to move the pixels Px to positions displaced by half a pixel toward the positive and negative ends of the F1 direction and toward the positive and negative ends of the F2 direction.

The positions where the pixel PXs are displayed on the projection receiving surface PS are each thus shifted from a first position P1 to a second position P2 displaced therefrom by half a pixel toward the positive end of the F2 direction, from the second position P2 to a third position P3 displaced therefrom by half a pixel toward the negative end of the F1 direction, and from the third position P3 to a fourth position P4 displaced therefrom by half a pixel toward the negative end of the F2 direction. The second position P2, the third position P3, and the fourth position P4 correspond to positions shifted from the first position P1. Note that the reference position is the position where the projected image is displayed when the pixels Px are each displayed at the first position P1. Furthermore, the amount of displacement of each of the positions P2 to P4 from the first position P1 is not limited to half a pixel, and may, for example, be ¼ or ¾ of each of the pixels Px.

The control apparatus 6 causes the optical path shifter 7 to shift the optical path of the image light PL in such a way that the pixels Px are each displayed at each of the positions P1, P2, P3, and P4 for a predetermined period of time to change the contents displayed by the light modulation modules 35R, 35G, and 35B in synchronization with the optical path shift. Pixels A, B, C, and D each having a size apparently smaller than the size of the pixel Px can therefore be displayed.

For example, to display the pixels A, B, C, and D as a whole at the frequency of 60 Hz, the contents displayed at the light modulators 351R, 351G, and 351B need to be switched at the frequency four times higher than 60 Hz in correspondence with the positions P1, P2, P3, and P4. In this case, a projected image having apparently higher resolution can be displayed by setting the refresh rate of the light modulators 351 at 240 Hz and causing the light modulators 351 to successively form image light containing the pixel A displayed at the first position P1, image light containing the pixel B displayed at the second position P2, image light containing the pixel C displayed at the third position P3, and image light containing the pixel D displayed at the fourth position P4.

### Detailed Configuration of Optical Path Shifter

The optical path shifter 7 includes a first movable section 72, a second movable section 73, a base 74, the first driver 75, and the second driver 76 as well as the optical path changing member 71, as shown in FIG. 9.

### Configuration of First Movable Section

The first movable section 72 is formed in the shape of a rectangular frame, the optical path changing member 71, and further holds first magnets 752 and 756 of the first driver 75. The first movable section 72 is supported by the second movable section 73 swingably around a first swing axis Rx1. The first movable section 72 includes a shaft section 721 and a fixing section 722.

The shaft section 721 includes a shaft section 7211, which protrudes from an outer circumferential portion of the first movable section 72 toward the positive end of the X direction and a shaft section 7212, which protrudes from an outer circumferential portion of the first movable section 72 toward the negative end of the X direction. The shaft sections 7211 and 7212 are inserted into the second movable section 73, so that the first movable section 72 is supported by the second movable section 73 swingably around the first swing axis Rx1. That is, the extension of the center axis of the shaft section 7211 and the extension of the center axis of the shaft section 7212 coincide with each other, and the extensions of the center axes of the shaft sections 7211 and 7212 form the first swing axis Rx1 along the X-axis.

The fixing section 722 includes a fixing section 7221, which protrudes from an outer circumferential portion of the first movable section 72 toward the positive end of the Y direction, and a fixing section 7222, which protrudes from an outer circumferential portion of the first movable section 72 toward the negative end of the Y direction. The first magnet 752 of the first driver 75 is fixed to the front end of the fixing section 7221, and the first magnet 756 of the first driver 75 is fixed to the front end of the fixing section 7222. Note that the fixing sections 7221 and 7222 function as yokes for the first magnets 752 and 756, respectively.

### Configuration of Second Movable Section

The second movable section 73 is formed in the shape of a frame, holds the first movable section 72 swingably around the first swing axis Rx1, and further holds first coils 753 and 757 of the first driver 75 and second magnets 762 and 766 of the second driver 76. The second movable section 73 includes a rotation support section 731, a support section 732, a shaft section 733, and an arm section 734.

The rotation support section 731 includes a rotation support section 7311 provided at an inner edge of the second movable section 73 that is the inner edge facing the negative end of the X direction, and a rotation support section 7312 provided at an inner edge of the second movable section 73 that is the inner edge facing the positive end of the X direction. The rotation support section 7311 rotatably supports the shaft section 7211, and the rotation support section 7422 rotatably supports the shaft section 7212. The first movable section 72 is thus supported by the second movable section 73 swingably around the first swing axis Rx1.

The support section 732 includes a support section 7321 provided at an inner edge of the second movable section 73 that is the inner edge facing the negative end of the Y direction, and a support section 7322 provided at an inner edge of the second movable section 73 that is the inner edge facing the positive end of the Y direction. The support section 7321 supports the first coil 753 of the first driver 75, and the support section 7322 supports the first coil 757 of the first driver 75.

The shaft section 733 includes a shaft section 7331, which protrudes from an outer circumferential portion of the second movable section 73 toward the positive end of the Y direction, and a shaft section 7332, which protrudes from an outer circumferential portion of the second movable section 73 toward the negative end of the Y direction. The shaft sections 7331 and 7332 are inserted into the base 74, so that the second movable section 73 is supported by the base 74 swingably around the second swing axis Rx2. The extension of the center axis of the shaft section 7331 and the extension of the center axis of the shaft section 7332 coincide with each other, and the extensions of the center axes of the shaft sections 7331 and 7332 form the second swing axis Rx2.

The arm section 734 is a portion protruding from the second movable section 73 toward the negative end of the Y direction. The arm section 734 includes an arm section 7341 provided at the side facing the positive end of the X direction, and an arm section 7342 provided at the side facing the negative end of the X direction. The second magnet 762 of the second driver 76 is fixed to the arm section 7341, and the second magnet 766 of the second driver 76 is fixed to the arm section 7342.

### Configuration of Base

The base 74 is formed in the shape of a frame having an opening 741 according to the outer shape of the second movable section 73. The base 74 holds the second movable section 73 swingably around the second swing axis Rx2 and further holds second coils 763 and 767 of the second driver 76. The base 74 includes a rotation support section 742 and a support section 743.

The rotation support section 742 includes a rotation support section 7421 provided at an inner edge of the base 74 that is the inner edge facing the negative end of the Y direction, and a rotation support section 7422 provided at an inner edge of the base 74 that is the inner edge facing the positive end of the Y direction. The rotation support section 7421 rotatably supports the shaft section 7331, and the rotation support section 7422 rotatably supports the shaft section 7332. The second movable section 73 is thus supported by the base 74 swingably around the second swing axis Rx2.

The support section 743 includes a support section 7431 provided at an inner edge of the second movable section 73 that is the inner edge facing the negative end of the X direction, and a support section 7432 provided at an inner edge of the second movable section 73 that is the inner edge facing the positive end of the X direction. The support section 7431 supports the second coil 763 of the second driver 76, and the support section 7432 supports the second coil 767 of the second driver 76.

### Configuration of First Driver

The first driver 75 swings the optical path changing member 71 around the first swing axis Rx1 by swinging the first movable section 72 around the first swing axis Rx1. The first driver 75 includes a first actuator 751 and a second actuator 755, which are disposed at positions on the second swing axis Rx2 symmetrically with respect to the first swing axis Rx1.

The first actuator 751 is disposed at a position shifted from the first swing axis Rx1 toward the positive end of the Y direction, and the second actuator 755 is disposed at a position shifted from the first swing axis Rx1 toward the negative end of the Y direction.

The first actuator 751 is a voice coil motor including the first magnet 752 fixed to the first movable section 72 and the first coil 753 supported by the second movable section 73.

The second actuator 755 is a voice coil motor including the first magnet 756 fixed to the first movable section 72 and the first coil 757 supported by the second movable section 73.

The control apparatus 6 supplies the first coils 753 and 757 with AC currents that are opposite in phase to each other to swing the optical path changing member 71 held by the first movable section 72 around the first swing axis Rx1.

### Configuration of Second Driver

The second driver 76 swings the optical path changing member 71 around the second swing axis Rx2 perpendicular to the first swing axis Rx1 by swinging the second movable section 73.

The second driver 76 includes a first actuator 761 and a second actuator 765, which are disposed at positions shifted from the first swing axis Rx1 toward the negative end of the Y direction and disposed symmetrically with respect to the second swing axis Rx2.

The first actuator 761 is disposed at a position shifted from the second swing axis Rx2 toward the positive end of the X direction, and the second actuator 765 is disposed at a position shifted from the second swing axis Rx2 toward the negative end of the X direction.

The first actuator 761 is a voice coil motor including the second magnet 762 fixed to the second movable section 73 and the second coil 763 supported by the base 74.

The second actuator 765 is a voice coil motor including the second magnet 766 fixed to the second movable section 73 and the second coil 767 supported by the base 74.

The control apparatus 6 supplies the second coils 763 and 767 with AC currents that are opposite in phase to each other to swing the second movable section 73 around the second swing axis Rx2 relative to the base 74, so that the optical path changing member 71 is swung around the second swing axis Rx2.

### Drive Waveform Generated by Drive Waveform Generation Section

The drive waveform generation section 64 of the control apparatus 6 generates a drive waveform used to drive the optical path shifter 7, as the drive waveform generation section 64 according to the first embodiment does. Specifically, the drive waveform generation section 64 generates a first drive waveform used to drive the first driver 75 and a second drive waveform used to drive the second driver 76.

Drive Waveform Generated when Amplitude is Smaller than Predetermined Threshold

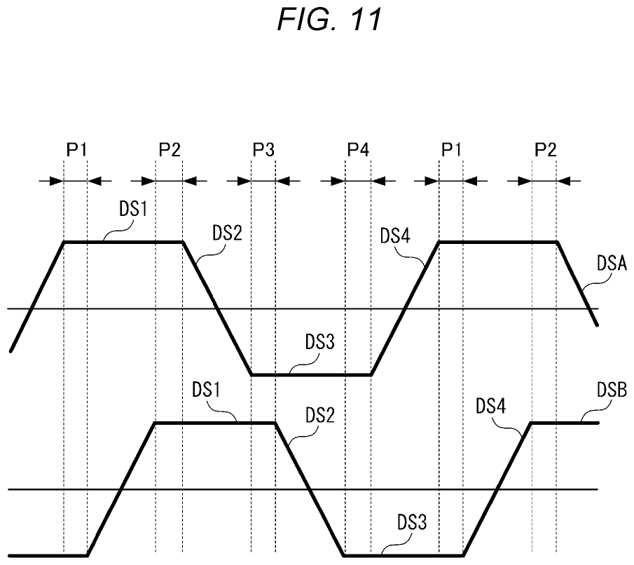

FIG. 11 shows an example of drive waveforms DSA and DSB generated when the amplitude of the vibration is smaller than the predetermined threshold.

When the amplitude of the detected vibration is determined by the amplitude evaluation section 62 to be smaller than the predetermined threshold, the drive waveform generation section 64 generates a first drive waveform DSA and a second drive waveform DSB shown in FIG. 11.

The first drive waveform DSA shown in the upper portion of FIG. 11 is the drive waveform used by the shift operation control section 65 to drive the first driver 75. In detail, the first drive waveform DSA is a drive waveform used by the shift operation control section 65 to operate the first driver 75 to swing the optical path changing member 71 around the first swing axis Rx1, which extends along the X-axis, toward the positive and negative ends of the Y direction. In the present embodiment, the first drive waveform DSA is a drive waveform used by the first driver 75 to shift the optical path of the image light PL toward the positive and negative ends of the F1 direction at the projection receiving surface PS.

The second drive waveform DSB shown in the lower portion of FIG. 11 is the drive waveform used by the shift operation control section 65 to drive the second driver 76. In detail, the second drive waveform DSB is a drive waveform used by the shift operation control section 65 to operate the second driver 76 to swing the optical path changing member 71 around the second swing axis Rx2, which extends along the Y-axis, toward the positive and negative ends of the X direction. In the present embodiment, the second drive waveform DSB is a drive waveform used by the second driver 76 to shift the optical path of the image light PL toward the positive and negative ends of the F2 direction at the projection receiving surface PS.

The first drive waveform DSA and the second drive waveform DSB are each a trapezoidal waveform that is the same as the drive waveform DS according to the first embodiment, and each include the top portion DS1, the gradually decreasing portion DS2, the bottom portion DS3, and the gradually increasing portion DS4, which together constitute one cycle of the drive waveform.

When the positive-pole-side voltage based on the first drive waveform DSA is applied to the first coil 753 of the first driver 75, the optical path changing member 71 shifts the optical path of the image light toward the positive end of the Y direction. The projected image is thus shifted toward the positive end of the F1 direction at the projection receiving surface PS.

When the negative-pole-side voltage based on the first drive waveform DSA is applied to the first coil 753 of the first driver 75, the optical path changing member 71 shifts the optical path of the image light toward the negative end of the Y direction. The projected image is thus shifted toward the negative end of the F1 direction at the projection receiving surface PS.

When the positive-pole-side voltage based on the second drive waveform DSB is applied to the second coil 763 of the second driver 76, the optical path changing member 71 shifts the optical path of the image light toward the positive end of the X direction. The projected image is thus shifted toward the positive end of the F2 direction at the projection receiving surface PS.

When the negative-pole side-voltage based on the second drive waveform DSB is applied to the second coil 763 of the second driver 76, the optical path changing member 71 shifts the optical path of the image light toward the negative end of the X direction. The projected image is thus shifted toward the negative end of the F2 direction at the projection receiving surface PS.

The frequency of each of the first drive waveform DSA and the second drive waveform DSB is equal to the frequency of the drive waveform DS.

The phase of the second drive waveform DSB is displaced with respect to the phase of the first drive waveform DSA.

Specifically, the phase of the second drive waveform DSB is so displaced with respect to the phase of the first drive waveform DSA that part of the period of the top portion DS1 of the first drive waveform DSA overlaps with part of the period of the bottom portion DS3 of the second drive waveform DSB and part of the period of the bottom portion DS3 of the first drive waveform DSA overlaps with part of the period of the bottom portion DS3 of the second drive waveform DSB.

In the example in FIG. 11, the period from the start of the top portion DS1 of the first drive waveform DSA to the end of the bottom portion DS3 of the second drive waveform DSB is the period for which the first driver 75 and second driver 76 each stop operating and the projected image is displayed at the first position P1.

The period from the start of the top portion DS1 of the second drive waveform DSB to the end of the top portion DS1 of the first drive waveform DSA is the period for which the first driver 75 and second driver 76 each stop operating and the projected image is displayed at the second position P2.

The period from the start of the bottom portion DS3 of the first drive waveform DSA to the end of the top portion DS1 of the second drive waveform DSB is the period for which the first driver 75 and second driver 76 each stop operating and the projected image is displayed at the third position P3.

The period from the start of the bottom portion DS3 of the second drive waveform DSB to the end of the bottom portion DS3 of the first drive waveform DSA is the period for which the first driver 75 and second driver 76 each stop operating and the projected image is displayed at the fourth position P4.

The shift operation control section 65 can position the projected image at each of the positions P1 to P4 by driving the first driver 75 based on the first drive waveform DSA and driving the second driver 76 based on the second drive waveform DSB. The resolution of the projected image can therefore be improved in a pseudo manner.

Drive Waveform Generated when Amplitude is Greater than or Equal to Predetermined Threshold

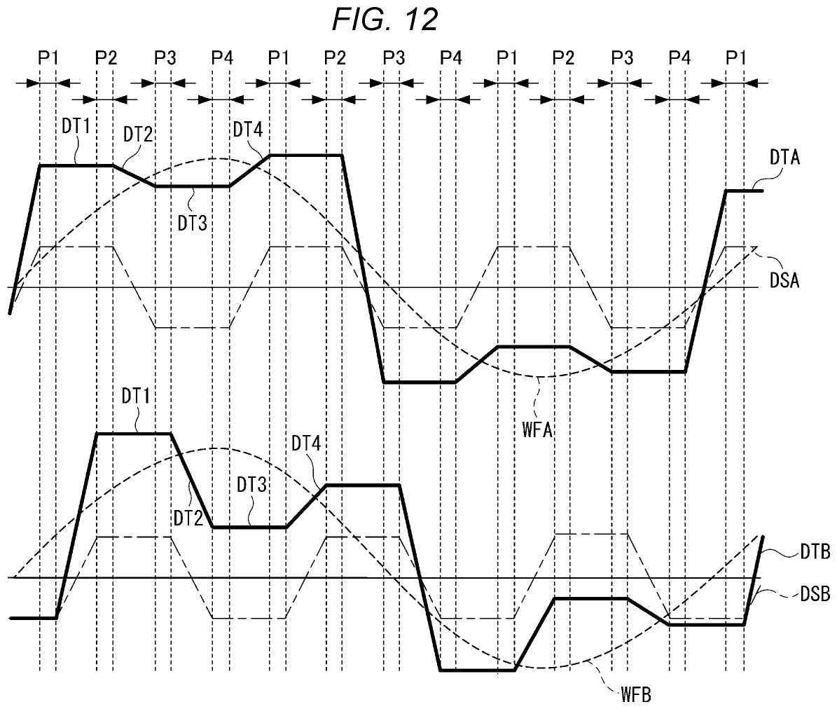

FIG. 12 shows an example of drive waveforms DTA and DTB generated when the amplitude of the vibration is greater than or equal to the predetermined threshold. FIG. 12 shows the drive waveforms DSA and DSB drawn by the chain line.

On the other hand, when the amplitude of the detected vibration is determined by the amplitude evaluation section 62 to be greater than or equal to the predetermined threshold, the drive waveform generation section 64 generates a first drive waveform DTA and a second drive waveform DTB, examples of which are shown in FIG. 12. In detail, when the amplitude evaluation section 62 determines that the amplitude of the vibration along the Y-axis is greater than or equal to the predetermined threshold, the drive waveform generation section 64 generates the first drive waveform DTA, an example of which is shown in the upper portion of FIG. 12, and when the amplitude evaluation section 62 determines that the amplitude of the vibration along the X-axis is greater than or equal to the predetermined threshold, the drive waveform generation section 64 generates the second drive waveform DTB, an example of which is shown in the lower portion of FIG. 12. The first drive waveform DTA and the second drive waveform DTB are each a trapezoidal waveform including the top portion DT1, the gradually decreasing portion DT2, the bottom portion DT3, and the gradually increasing portion DT4, which together constitute one cycle.

Vibration suppression waveforms WFA and WFB and the drive waveforms DTA and DTB shown in FIG. 12 are vibration waveforms having the opposite phase and drive waveforms, respectively, in a case where the vibration affects the position where the projection optical apparatus 37 projects the image light and acts in a direction inclining with respect to each of the X-axis and the Y-axis. That is, the vibration suppression waveforms WFA and WFB and the drive waveforms DTA and DTB, examples of which are shown in the upper portion of FIG. 12, are vibration waveforms having the opposite phase and drive waveforms, respectively, in a case where vibration in a direction inclining with respect to each of the F1 directions toward the positive and negative ends thereof and the F2 directions toward the positive and negative ends thereof acts on the projected image at the projection receiving surface PS.

The first drive waveform DTA shown in the upper portion of FIG. 12 is a drive waveform used by the shift operation control section 65 to drive the first driver 75. The first drive waveform DTA is a drive waveform as a result of multiplication of the first drive waveform DSA by the vibration suppression waveform WFA having a phase opposite the phase of the vibration along the Y-axis, which is perpendicular to each of the axis along the optical axis along which the image formation apparatus 33 outputs the image light PL and the first swing axis Rx1, out of the vibration detected by the vibration detection sensor 5.

In the present embodiment, the first drive waveform DTA is a drive waveform as a result of causing the first drive waveform DSA to approximate to the vibration suppression waveform WFA generated by the vibration waveform generation section 63 to suppress the vibration that swings the projected image toward the positive and negative ends of the F1 direction on the projection receiving surface PS. Note that the axis along which the image formation apparatus 33 outputs the image light PL is an axis along the Z-axis.

The second drive waveform DTB shown in the lower portion of FIG. 12 is the drive waveform used by the shift operation control section 65 to drive the second driver 76. The second drive waveform DTB is a drive waveform as a result of multiplication of the second drive waveform DSB by the vibration suppression waveform WFB having a phase opposite the phase of the vibration along the X-axis, which is perpendicular to each of the axis along the optical axis along which the image formation apparatus 33 outputs the image light PL and the second swing axis Rx2, out of the vibration detected by the vibration detection sensor 5.

In the present embodiment, the second drive waveform DTB is a drive waveform as a result of causing the second drive waveform DSB to approximate to the vibration suppression waveform WFB generated by the vibration waveform generation section 63 to suppress the vibration that swings the projected image toward the positive and negative ends of the F2 direction on the projection receiving surface PS.

The method for generating the first drive waveform DTA and the second drive waveform DTB is the same as the method for generating the drive waveform DT shown in the first embodiment.

That is, when the amplitude of the vibration acting along the Y-axis and detected by the vibration detection sensor 5 is greater than or equal to predetermined first threshold, the drive waveform generation section 64 generates the first drive waveform DTA, which approximates to the vibration suppression waveform WFA for suppressing the vibration along the Y-axis, by using the same method for generating the drive waveform DT shown in the first embodiment. The first drive waveform DTA is a drive waveform that reduces the vibration along the Y-axis.

When the amplitude of the vibration acting along the X-axis and detected by the vibration detection sensor 5 is greater than or equal to a predetermined second threshold, the drive waveform generation section 64 generates the second drive waveform DTB, which approximates to the vibration suppression waveform WFB for suppressing the vibration along the X-axis, by using the same method for generating the drive waveform DT shown in the first embodiment. The second drive waveform DTB is a drive waveform that reduces the vibration along the X-axis.

The first and second thresholds may be equal to each other or may differ from each other.

The phase of the second drive waveform DTB is so displaced with respect to the phase of the first drive waveform DTA that part of the period of the top portion DT1 of the first drive waveform DTA overlaps with part of the period of the bottom portion DT3 of the second drive waveform DTB and part of the period of the bottom portion DT3 of the first drive waveform DTA overlaps with part of the period of the bottom portion DT3 of the second drive waveform DTB, as in the case of the drive waveforms DSA and DSB.

The periods of the drive waveforms DTA and DTB, for which the projected image is displayed at the positions from P1 to P4, are equal to the periods of the drive waveforms DSA and DSB.

The shift operation control section 65 can position the projected image at each of the positions P1 to P4 while suppressing the vibration that affects the position where the image light PL is projected by driving the first driver 75 based on the first drive waveform DTA and driving the second driver 76 based on the second drive waveform DTB. The resolution of the projected image can therefore be improved in a pseudo manner with the swing motion of the projected image due to the vibration suppressed.

### Other Drive Waveforms for Suppressing Vibration

The drive waveforms DTA and DTB shown in FIG. 12 are drive waveforms generated when vibration in a direction inclining with respect to each of the X-axis and the Y-axis acts, as described above. That is, the first drive waveform DTA shown in FIG. 12 is an example of the drive waveform generated when the amplitude of the vibration along the Y-axis is greater than or equal to the predetermined first threshold, and the second drive waveform DTB shown in FIG. 12 is an example of the drive waveform generated when the amplitude of the vibration along the X-axis is greater than or equal to the predetermined second threshold.

In contrast, when the amplitude of the vibration along one of the X-axis and the Y-axis is greater than or equal to the predetermined threshold and the amplitude of the vibration along the other axis is smaller than the predetermined threshold, the drive waveform used to operate the driver that shifts the optical path of the image light along the other axis is one of the drive waveforms DSA and DSB.

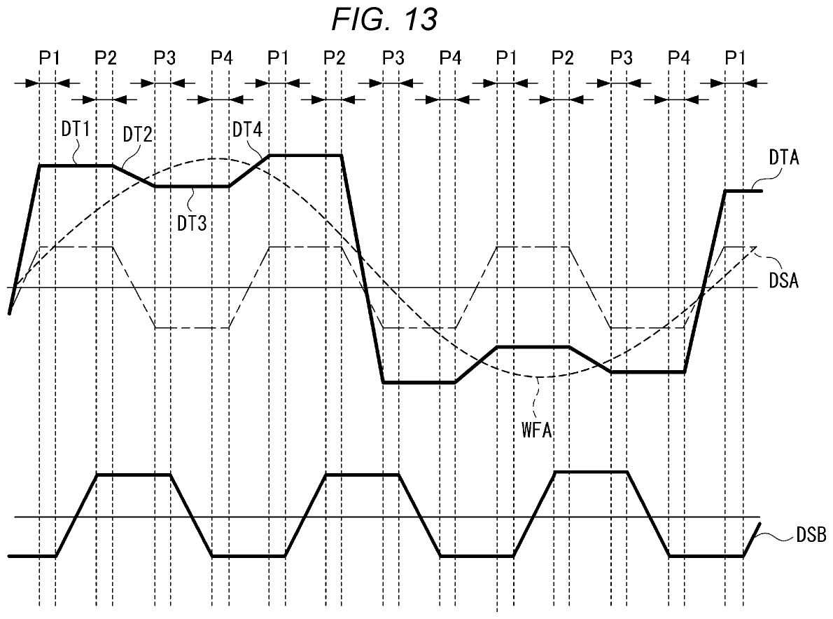

FIG. 13 shows another example of the drive waveform generated by the drive waveform generation section 64. FIG. 13 shows the drive waveform DSA drawn by the chain line.

For example, when the amplitude of the vibration along the Y-axis is greater than or equal to the first threshold, but the amplitude of the vibration along the X-axis is smaller than the second threshold, the drive waveform generation section 64 generates the first drive waveform DTA, which approximates to the vibration suppression waveform WFA for suppressing the detected vibration along the Y-axis, as the drive waveform used to drive the first driver 75, and generates the second drive waveform DSB as the drive waveform used to drive the second driver 76, as shown in FIG. 13.

The shift operation control section 65 can drive the drivers 75 and 76 based on the thus generated drive waveforms DTA and DSB to improve the resolution of the projected image in a pseudo manner while suppressing the swing motion of the projected image due to the vibration along the Y-axis.

On the other hand, although not shown, when the amplitude of the vibration along the Y-axis is smaller than the first threshold, but the amplitude of the vibration along the X-axis is greater than or equal to the second threshold, the drive waveform generation section 64 generates the first drive waveform DSA as the drive waveform used to drive the first driver 75, and generates the second drive waveform DTB, which approximates to the vibration suppression waveform WFB for suppressing the detected vibration along the X-axis, as the drive waveform used to drive the second driver 76.

The shift operation control section 65 can drive the drivers 75 and 76 based on the thus generated drive waveforms DSA and DTB to improve the resolution of the projected image in a pseudo manner while suppressing the swing motion of the projected image due to the vibration along the X-axis.

### Effects of Second Embodiment

The projector according to the present embodiment described above provides the effects below as well as the same effects provided by the projector according to the first embodiment.

The projector according to the present embodiment includes the optical path shifter 7. The optical path shifter 7 includes the first driver 75, which swings the optical path changing member 71 around the first swing axis Rx1, and the second driver 76, which swings the optical path changing member 71 around the second swing axis Rx2, which intersects with the first swing axis Rx1.

The vibration detection sensor 5 detects first vibration in the Y direction toward the positive and negative ends thereof perpendicular to each of the axis along the optical axis along which the image formation apparatus 33 outputs the image light and the first swing axis Rx1, and detects second vibration in the X direction toward the positive and negative ends thereof perpendicular to each of the axis along the optical axis along which the image formation apparatus 33 outputs the image light and the second swing axis Rx2. That is, the vibration detection sensor 5 detects the first vibration along the Y-axis and the second vibration along the X-axis.

When the amplitude of the first vibration is greater than or equal to the predetermined first threshold, the drive waveform generation section 64 generates the first drive waveform DTA, which approximates to the vibration suppression waveform WFA, which is a vibration waveform having a phase opposite the phase of the first vibration. When the amplitude of the second vibration is greater than or equal to the predetermined second threshold, the drive waveform generation section 64 generates the second drive waveform DTB, which approximates to the vibration suppression waveform WFB, which is a vibration waveform having a phase opposite the phase of the second vibration.

The shift operation control section 65 controls the optical path shifter 7 based on any of the drive waveforms generated by the drive waveform generation section 64.

According to the configuration described above, the number of positions where the image light PL is projected onto the projection receiving surface PS can be increased as compared with the case where the optical path shifter 4 according to the first embodiment is employed. The resolution of the projected image can thus be increased in a pseudo manner.

Furthermore, operating the first driver 75 based on the first drive waveform DTA and operating the second driver 76 based on the second drive waveform DTB allows an increase in the number of directions in which the swing motion of the projected image can be suppressed on the projection receiving surface PS. The swing motion of the projected image can therefore be further suppressed.

### Variations of Embodiments

The present disclosure is not limited to the embodiments described above, and variations, improvements, and other modifications to the extent that the advantage of the present disclosure is achieved fall within the scope of the present disclosure.

It is assumed in the first embodiment described above that the optical path shifter 4 includes the driver 44 including the first actuator 441 and the second actuator 442. It is assumed in the second embodiment described above that the optical path shifter 7 includes the first driver 75 including the first actuator 751 and the second actuator 755, and the second driver 76 including the first actuator 761 and the second actuator 765. The configurations described above may not necessarily be employed, and the driver 44 may include only one of the first actuator 441 and the second actuator 442. The first driver 75 may include only one of the first actuator 751 and the second actuator 755, and the second driver 76 may include only one of the first actuator 761 and the second actuator 765.

It is assumed in the second embodiment described above that the first swing axis Rx1 extends along the X-axis and the second swing axis Rx2 extends along the Y-axis, but not necessarily. The first swing axis Rx1 and the second swing axis Rx2 may each extend in a direction that is perpendicular to the Z-axis and intersects with each of the X-axis and the Y-axis.

It is assumed in each of the embodiments described above that the projector includes the three light modulation modules 35R, 35G, and 35B, but not necessarily. The projector may include two or fewer or four or more light modulation modules.

It is assumed in each of the embodiments described above that the image projection unit 3 includes the optical parts arranged in the layout shown in FIG. 1, but not necessarily. The layout and configuration of the image projection unit employed in the projector according to the present disclosure are not limited to those described above and can be changed as appropriate.

It is assumed in the embodiments described above that the optical axis from the light combiner 36 to the light exiting end of the projection optical apparatus 37 extends linearly, and that the projection optical apparatus 37 outputs the image light toward the positive end of the Z direction, but not necessarily. The direction in which the projection optical apparatus outputs the image light may be the Z direction toward the negative end thereof, which is the opposite direction of the Z direction toward the positive end thereof, with the aid, for example, of a reflection mirror. The optical axis of the projection optical apparatus may be deflected by an optical path changing mirror into an optical axis having an L-letter shape, so that the direction in which the projection optical apparatus outputs the image light is the X direction toward the positive or negative end thereof. In this case, the optical path shifter 4 is disposed in the optical path between the light combiner 36 and the optical path changing mirror.

The present disclosure is also applicable to a projector based on a scheme in which one light modulator forms image light. In this scheme, in which no light combiner is used, the optical path shifter 4 is disposed between the light modulator and the projection optical apparatus.

The present disclosure is still also applicable to a projector including height-adjustable legs and capable of changing the direction in which the projection optical apparatus outputs light by using the leg height adjustment function. The present disclosure is applicable not only to a projector installed at an installation surface such as a stand, but also to a projector installed at an installation surface such as a ceiling or a wall by using an attachment apparatus.

It is assumed in each of the embodiments described above that the light modulators 351 are each formed of a transmissive liquid crystal panel having a light incident surface and a light exiting surface different from each other, but not necessarily. The light modulators may each instead be formed of a reflective liquid crystal panel having a surface that serves both as the light incident surface and the light exiting surface. Still instead, a light modulator using any component other than a liquid-crystal-based component and capable of modulating an incident luminous flux to form an image according to image information, such as a device using micromirrors, for example, a digital micromirror device (DMD), may be employed. In this case, the light-incident-side polarizers 352 and the light-exiting-side polarizers 353 can be omitted.

### SUMMARY OF PRESENT DISCLOSURE

The present disclosure will be summarized below as additional remarks.

### Additional Remark 1

A projector including an image formation apparatus that forms image light from illumination light that enters the image formation apparatus, a projection optical apparatus that projects the image light formed by the image formation apparatus, an optical path shifter that is disposed in the optical path of the image light between the image formation apparatus and the projection optical apparatus and shifts the optical path of the image light with respect to a reference position where the image light is projected, a vibration detection sensor that detects vibration that affects the position where the projection optical apparatus projects the image light, and a control section that controls the optical path shifter, the control section acquiring the result of detection performed by the vibration detection sensor, generating a vibration waveform having a phase opposite the phase of the waveform of the vibration based on the acquired detection result, generating a drive waveform that approximates to the vibration waveform having the opposite phase, and driving the optical path shifter based on the generated drive waveform.

According to the configuration described above, the control section operates the optical path shifter based on the drive waveform, which approximates to the vibration waveform having a phase opposite the phase of the waveform of the detected vibration. Therefore, even when the image light projected onto the projection receiving surface swings due to the vibration, the resolution of the projected image can be improved in a pseudo manner with the swing motion of the projected image displayed on the projection receiving surface reduced. Reduction in the swing motion of the projected image and improvement in the resolution of the image in a pseudo manner can therefore be both achieved.

### Additional Remark 2

The projector described in the additional remark 1, in which the drive waveform is a trapezoidal waveform, a top portion of the trapezoidal waveform approximates to the amount of displacement of the vibration waveform having the opposite phase and corresponding to the top portion, and a bottom portion of the trapezoidal waveform approximates to the amount of displacement of the vibration waveform having the opposite phase and corresponding to the bottom portion.

According to the configuration described above, the optical path shifter can be operated in accordance with the amount of displacement of the vibration. That is, the optical path shifter can shift the image light in the opposite direction of the direction of the vibration in accordance with the amount of displacement of the projected image due to the vibration at the projection receiving surface. The swing motion of the projected image can therefore be further reduced.

### Additional Remark 3

The projector described in the additional remark 2, in which the potential of the top portion is set to be higher than the amount of displacement of the vibration waveform having the opposite phase and corresponding to the top portion, and the potential of the bottom portion is set to be lower than the amount of displacement of the vibration waveform having the opposite phase and corresponding to the bottom portion.

According to the configuration described above, when an optical path shifter that switches the voltage supplied thereto to shift the optical path of the image light is employed, the potential of the top portion of the drive waveform is set to be higher and the potential of the bottom portion of the drive waveform is set to be lower than the amount of displacement of the generated vibration waveform having the opposite phase, so that the optical path shifter can be operated in accordance with the vibration waveform having the opposite phase. Therefore, when the resolution of the image is improved in a pseudo manner, the projected image displayed at the projection receiving surface can be moved in the opposite direction of the direction of the vibration in accordance with the amount of displacement of the image. The swing motion of the projected image at the projection receiving surface can therefore be effectively suppressed.

### Additional Remark 4

A control apparatus that controls an optical path shifter of a projector including an image formation apparatus that forms image light from illumination light that enters the image formation apparatus, a projection optical apparatus that projects the image light formed by the image formation apparatus, the optical path shifter disposed in the optical path of the image light between the image formation apparatus and the projection optical apparatus and shifting the optical path of the image light with respect to a reference position where the image light is projected, and a vibration detection sensor that detects vibration that affects the position where the projection optical apparatus projects the image light, the control apparatus acquiring the result of detection performed by the vibration detection sensor, generating a vibration waveform having a phase opposite the phase of the waveform of the vibration based on the acquired detection result, generating a drive waveform that approximates to the vibration waveform having the opposite phase, and driving the optical path shifter based on the generated drive waveform.

The configuration described above can provide the same effects those provided by the projector described in the additional remark 1.

### Additional Remark 5

The control apparatus described in the additional remark 4, in which the drive waveform is a trapezoidal waveform, a top portion of the trapezoidal waveform approximates to the amount of displacement of the vibration waveform the having opposite phase and corresponding to the top portion, and a bottom portion of the trapezoidal waveform approximates to the amount of displacement of the vibration waveform having the opposite phase and corresponding to the bottom portion.

The configuration described above can provide the same effects as those provided by the projector described in the additional remark 2.

### Additional Remark 6

The control apparatus described in the additional remark 5, in which the potential of the top portion is set to be higher than the amount of displacement of the vibration waveform having the opposite phase and corresponding to the top portion, and the potential of the bottom portion is set to be lower than the amount of displacement of the vibration waveform having the opposite phase and corresponding to the bottom portion.

The configuration described above can provide the same effects as those provided by the projector described in the additional remark 3.

What is claimed is:

1. A projector comprising:
an image formation apparatus that forms image light from illumination light that enters the image formation apparatus;
a projection optical apparatus that projects the image light formed by the image formation apparatus;
an optical path shifter that is disposed in an optical path of the image light between the image formation apparatus and the projection optical apparatus and shifts the optical path of the image light with respect to a reference position where the image light is projected;
a vibration detection sensor that detects vibration that affects the position where the projection optical apparatus projects the image light; and
a control section that controls the optical path shifter,
wherein the control section
acquires a result of detection performed by the vibration detection sensor,
generates a vibration waveform having a phase opposite a phase of a waveform of the vibration based on the acquired detection result,
generates a drive waveform that approximates to the vibration waveform having the opposite phase, and
drives the optical path shifter based on the generated drive waveform.

2. The projector according to claim 1,
wherein the drive waveform is a trapezoidal waveform,
a top portion of the trapezoidal waveform approximates to an amount of displacement of the vibration waveform having the opposite phase and corresponding to the top portion, and
a bottom portion of the trapezoidal waveform approximates to an amount of displacement of the vibration waveform having the opposite phase and corresponding to the bottom portion.

3. The projector according to claim 2,
wherein a potential of the top portion is set to be higher than the amount of displacement of the vibration waveform having the opposite phase and corresponding to the top portion, and
a potential of the bottom portion is set to be lower than the amount of displacement of the vibration waveform having the opposite phase and corresponding to the bottom portion.

4. The projector according to claim 1,
wherein when a frequency of swing motion of the image light projected by the projection optical apparatus is lower than or equal to 40 Hz, the control section generates the drive waveform that approximates to the vibration waveform having the opposite phase.

5. A control apparatus that controls an optical path shifter of a projector including an image formation apparatus that forms image light from illumination light that enters the image formation apparatus, a projection optical apparatus that projects the image light formed by the image formation apparatus, the optical path shifter disposed in an optical path of the image light between the image formation apparatus and the projection optical apparatus and shifting the optical path of the image light with respect to a reference position where the image light is projected, and a vibration detection sensor that detects vibration that affects the position where the projection optical apparatus projects the image light, wherein the control apparatus
acquires a result of detection performed by the vibration detection sensor,
generates a vibration waveform having a phase opposite a phase of a waveform of the vibration based on the acquired detection result,
generates a drive waveform that approximates to the vibration waveform having the opposite phase, and
drives the optical path shifter based on the generated drive waveform.

6. The control apparatus according to claim 5,
wherein the drive waveform is a trapezoidal waveform,
a top portion of the trapezoidal waveform approximates to an amount of displacement of the vibration waveform having the opposite phase and corresponding to the top portion, and
a bottom portion of the trapezoidal waveform approximates to an amount of displacement of the vibration waveform having the opposite phase and corresponding to the bottom portion.

7. The control apparatus according to claim 6,
wherein a potential of the top portion is set to be higher than the amount of displacement of the vibration waveform having the opposite phase and corresponding to the top portion, and
a potential of the bottom portion is set to be lower than the amount of displacement of the vibration waveform having the opposite phase and corresponding to the bottom portion.

8. The control apparatus according to claim 5,
wherein when a frequency of swing motion of the image light projected by the projection optical apparatus is lower than or equal to 40 Hz, the control apparatus generates the drive waveform that approximates to the vibration waveform having the opposite phase.
